(19) United States
(12) Patent Application Publication
(10) Pub. No.: US 2026/0253542 A1
(43) Pub. Date: Aug. 27, 2026

(54) DISPLAY DEVICE AND ELECTRONIC DEVICE HAVING THE SAME

(71) Applicant: Samsung Display Co., Ltd., Yongin-si (KR)

(72) Inventors: Jun Hyun PARK, Yongin-si (KR); Hwa Rang LEE, Yongin-si (KR); Jun Ki JEONG, Yongin-si (KR); Na Hyeon CHA, Yongin-si (KR)

(21) Appl. No.: 19/339,191

(22) Filed: Sep. 24, 2025

(30) Foreign Application Priority Data
Feb. 26, 2025 (KR) 10-2025-0025331

(51) Int. Cl. G09G 3/3233; G09G 3/20

(52) U.S. Cl. CPC G09G 3/3233; G09G 3/2092; G09G 2300/0819; G09G 2300/0852; G09G 2300/0861; G09G 2310/0286; G09G 2310/08; G09G 2330/021

(57) ABSTRACT

A display device includes: a pixel part including a plurality of pixels; and a driver configured to supply a gate control signal to each of the plurality of pixels, wherein the driver comprises at least one stage, and a first clock signal having an unchanging voltage value and a second clock signal having a changing voltage value are configured to be applied to the at least one stage during the self-scan period.

### CROSS-REFERENCE TO RELATED APPLICATION

The present application claims priority to and the benefit of Korean Patent Application Number 10-2025-0025331, filed on Feb. 26, 2025, in the Korean Intellectual Property Office, the entire disclosure of which is incorporated herein by reference.

### BACKGROUND

### 1. Field

Aspects of embodiments of the present disclosure relate to a display device and an electronic device having the same.

### 2. Description of the Related Art

With the development of information technology, the importance of display devices as a medium of connection between users and information is increasing. In response to this, the use of display devices such as liquid crystal display devices, organic light emitting display devices, and the like is increasing.

The above information disclosed in this Background section is only for enhancement of understanding of the background and therefore the information discussed in this Background section does not necessarily constitute prior art.

### SUMMARY

Aspects of some embodiments of the present disclosure include a display device that may be capable of relatively reducing power consumption and an electronic device having the same.

According to an aspect of embodiments of the present disclosure, a display device may include a pixel part including a plurality of pixels, and a driver supplying a gate control signal to each of the plurality of pixels, wherein the driver comprises at least one stage, and a first clock signal having an unchanging voltage value and a second clock signal having a changing voltage value are applied to the at least one stage during the self-scan period.

In one or more embodiments, the first clock signal and the second clock signal having changing voltage values may be supplied to the at least one stage during a display scan period.

In one or more embodiments, each of the plurality of pixels may include a driving transistor, a switching transistor, and a light emitting element, and the switching transistor may be connected to the driving transistor, and the at least one stage may generate the gate control signal, and the gate control signal may be input to a gate terminal of the switching transistor.

In one or more embodiments, the driver may include a first stage group and a second stage group, and each of the first stage group and the second stage group may include a plurality of stages, the plurality of stages included in the first stage group may supply first gate control signals to the plurality of pixels, respectively, the plurality of stages included in the second stage group may supply second gate control signals to the plurality of pixels, respectively, and the first clock signal having the unchanging voltage value and the second clock signal having the changing voltage value may be applied to the plurality of stages included in the second stage group during the self-scan period.

In one or more embodiments, each of the plurality of pixels may include a first transistor having a gate terminal connected to a first node, a fifth transistor connected between a first power supply voltage and the first transistor, a second transistor connected between a data line and the first node, a third transistor connected between a reference power supply voltage and the first node, a first capacitor connected between the first node and a second node, a second capacitor connected between the first power supply voltage and the second node, a sixth transistor connected between the second node and a third node, a fourth transistor connected between the third node and an initialization power supply voltage, and a light emitting element connected between the third node and a second power supply voltage.

In one or more embodiments, one of the first gate control signals may be input to a gate terminal of the fifth transistor of one of the plurality of pixels, and one of the second gate control signals may be input to a gate terminal of the sixth transistor of one of the plurality of pixels.

In one or more embodiments, the second clock signal may be supplied to the plurality of stages included in the first stage group.

In one or more embodiments, the first clock signal may not be supplied to the plurality of stages included in the first stage group.

According to an aspect of embodiments of the present disclosure, a display device may include a pixel part including a plurality of pixels, a driver connected to the pixel part through a plurality of gate control lines, and a timing controller receiving video data and controlling driving of the driver to display a video corresponding to the video data, wherein the driver comprises: a first stage group including a plurality of stages supplying first gate control signals to the plurality of pixels, respectively, and a second stage group including a plurality of stages supplying second gate control signals to the plurality of pixels, respectively, wherein the at least one stage included in the second stage group receives a clock signal having a changing voltage value through a first input terminal, and receives a signal of a direct current component having an unchanging voltage value through a second input terminal during a self-scan period.

In one or more embodiments, the at least one stage included in the second stage group may receive clock signals having changing voltage values through the first input terminal and the second input terminal, respectively, during a display scan period.

In one or more embodiments, each of the plurality of pixels may include: a first transistor having a gate terminal connected to a first node, a fifth transistor connected between a first power supply voltage and the first transistor, a second transistor connected between a data line and the first node, a third transistor connected between a reference power supply voltage and the first node, a first capacitor connected between the first node and a second node, a second capacitor connected between the first power supply voltage and the second node, a sixth transistor connected between the second node and a third node, a fourth transistor connected between the third node and an initialization power supply voltage, and a light emitting element connected between the third node and a second power supply voltage.

In one or more embodiments, the first gate control signal may be input to a gate terminal of the fifth transistor, and the second gate control signal may be input to a gate terminal of the sixth transistor.

In one or more embodiments, the clock signal input to the first input terminal of the at least one stage included in the second stage group may be commonly input to at least one stage included in the first stage group.

In one or more embodiments, the signal input to the second input terminal of the at least one stage included in the second stage group may not be input to the plurality of stages included in the first stage group.

According to an aspect of embodiments of the present disclosure, an electronic device may include a processor providing input video data, and an electronic device including a display device displaying a video based on the input video data, wherein the display device comprises: a pixel part including a plurality of pixels, and a driver supplying a gate control signal to each of the plurality of pixels, wherein the driver comprises at least one stage, and a first clock signal having an unchanging voltage value and a second clock signal having a changing voltage value are applied to the at least one stage during a self-scan period.

In one or more embodiments, the driver may include a first stage group and a second stage group, and each of the first stage group and the second stage group may include a plurality of stages, the plurality of stages included in the first stage group may supply first gate control signals to the plurality of pixels, respectively, the plurality of stages included in the second stage group may supply second gate control signals to the plurality of pixels, respectively, and the first clock signal having the unchanging voltage value and the second clock signal having the changing voltage value may be applied to the plurality of stages included in the second stage group during the self-scan period.

In one or more embodiments, each of the plurality of pixels may include: a first transistor having a gate terminal connected to a first node, a fifth transistor connected between a first power supply voltage and the first transistor, a second transistor connected between a data line and the first node, a third transistor connected between a reference power supply voltage and the first node, a first capacitor connected between the first node and a second node, a second capacitor connected between the first power supply voltage and the second node, a sixth transistor connected between the second node and a third node, a fourth transistor connected between the third node and an initialization power supply voltage, and a light emitting element connected between the third node and a second power supply voltage.

In one or more embodiments, one of the first gate control signals may be input to a gate terminal of the fifth transistor of one of the plurality of pixels, and one of the second gate control signals may be input to a gate terminal of the sixth transistor of one of the plurality of pixels.

In one or more embodiments, the second clock signal may be supplied to the plurality of stages included in the first stage group.

In one or more embodiments, the first clock signal may not be supplied to the plurality of stages included in the first stage group.

### BRIEF DESCRIPTION OF THE DRAWINGS

The above and other aspects and features of embodiments according to the present disclosure will become more apparent by describing, in further detail, aspects of some embodiments thereof with reference to the accompanying drawings, in which:

FIG. 1 is a block diagram illustrating a display device according to some embodiments of the present disclosure;

FIG. 2 is a circuit diagram illustrating aspects of a pixel shown in FIG. 1;

FIG. 3A is a block diagram illustrating a first stage group of an emission driver shown in FIG. 1 according to some embodiments;

FIG. 3B is a block diagram illustrating a second stage group of an emission driver shown in FIG. 1 according to some embodiments;

FIG. 4 is a circuit diagram illustrating aspects of one of a plurality of stages shown in FIG. 3A according to some embodiments;

FIG. 5 is a drawing illustrating an overall operation of a first stage group shown in FIG. 3A;

FIG. 6 is a conceptual diagram illustrating one example of a method of driving a display device based on a video refresh rate;

FIG. 7 is a block diagram illustrating an operation of a second stage group during a self-scan period according to some embodiments of the present disclosure;

FIG. 8 is a block diagram illustrating an operation of a second stage group during a self-scan period according to some embodiments of the present disclosure;

FIG. 9 is a diagram illustrating an electronic device according to some embodiments of the present disclosure; and

FIG. 10 shows schematic views of various embodiments of an electronic device.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In addition, configurations irrespective of the gist of the present disclosure may be omitted. It should be noted that in adding reference numerals to the components of each drawing, the same components have the same number if possible, even though the same components are shown in different drawings.

In addition, the thicknesses of layers and areas in the accompanying drawings may be exaggerated for clarity of illustration, and the present invention is not limited thereto. To clearly express a plurality of layers and areas on the drawings, the thickness may be exaggerated.

In addition, throughout the disclosure, the expression “the same” may mean “substantially the same.” That is, the word “same” may be defined to an extent that a person of ordinary skill in the art can be convinced to consider elements to be the same as each other. The term “substantially” may also be omitted from other expressions.

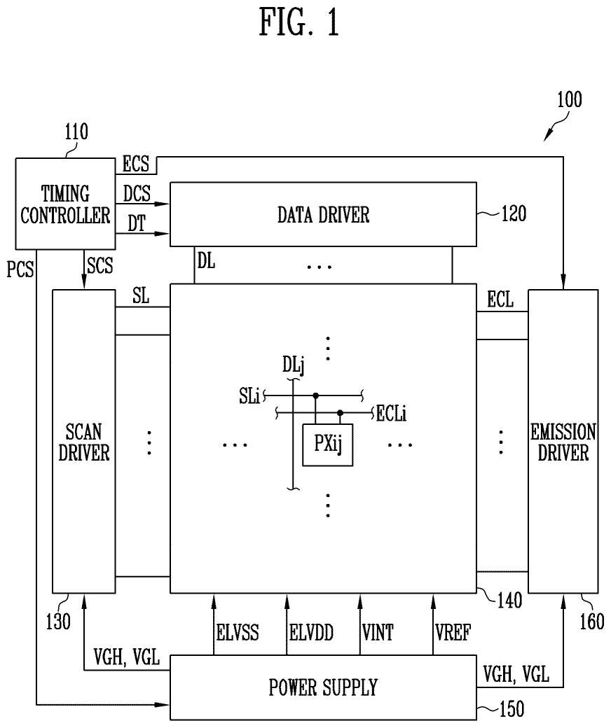

FIG. 1 is a block diagram illustrating a display device 100 according to some embodiments of the present disclosure.

Referring to FIG. 1, the display device 100 may include a timing controller 110, a data driver 120, a scan driver 130, a pixel part 140, a power supply 150, and an emission driver 160.

In a display mode, the display device 100 may display an image at various driving frequencies (or video refresh rates or screen refresh rates) depending on driving conditions. A driving frequency refers to a frequency at which a data signal is substantially written to driving transistors of pixels PX. For example, the driving frequency is also known as a screen scanning rate or a screen refresh frequency, and refers to the number of times a display screen is reproduced for one second. The display device 10 may display an image in response to various driving frequencies from 1 Hz to 120 Hz.

The timing controller 110 may receive frame information and control signals from an external processor. The timing controller 110 may convert the received frame information and control signals to conform to specifications of the display device 100 and may provide the converted information and signals to the data driver 120, the scan driver 130, the power supply 150, and the emission driver 160.

For example, the timing controller 110 may transfer data driving signals DCS and video (or image) data DT to the data driver 120. The data driving signals DCS may include sampling signals and/or timing signals for driving the data driver 120. Based on the data driving signals DCS and the video data DT, the data driver 120 may supply respective data signals to data lines DL. For example, the data driver 120 may generate data signals having analog data voltages corresponding to the gradation values included in the video data DT supplied as digital data, and may output the data signals to the data lines DL, respectively. The data signals which are output to the data lines DL may be supplied to the pixels, respectively. The scan driver 130 may receive scan driving signals SCS from the timing controller 110. The scan driving signals SCS may include sampling signals and/or timing signals for driving the scan driver 130. The scan driver 130 may supply the respective scan signals to the scan lines SL based on the scan driving signals SCS.

Each scan signal may have a gate-on voltage to turn on a transistor to which the scan signal is supplied. For example, a P-type transistor may be supplied with a low-level scan signal, and an N-type transistor may be supplied with a high-level scan signal. Accordingly, the transistors receiving the respective scan signals may be turned on in response to the scan signals.

The emission driver 160 may receive emission driving signals ECS from the timing controller 110. The emission driving signals ECS may include sampling signals and/or timing signals for driving the emission driver 160. The emission driver 160 may supply the respective emission control signals to emission control lines ECL based on the emission driving signals ECS. For example, the emission driver 160 may sequentially supply the emission control signals ECS to the emission control lines ECL based on the emission driving signals ECS.

Each of the emission control signals may have a gate-off voltage to turn off the transistor to which the emission control signal is supplied. For example, a P-type transistor may be supplied with the emission control signal at a high level, and an N-type transistor may be supplied with an emission control signal at a low level. Accordingly, the transistors receiving the respective emission control signals may be turned off in response to the emission control signals and may remain turned-off during a period in which the emission control signals are supplied.

While FIG. 1 illustrates embodiments in which the scan driver 130 and the emission driver 160 are provided as separate configurations, embodiments are not limited thereto. For example, the scan driver 130 and the emission driver 160 may be integrated into one drive circuit, one module, or the like.

The power supply 150 may receive power driving signals PCS from the timing controller 110. The power supply 150 may generate driving voltages of the pixels based on the power driving signals PCS, and may supply the driving voltages to the pixel part 140 through respective power lines. According to some embodiments, the power supply 150 may be a power management integrated circuit (PMIC) or may include a PMIC. For example, the power supply 150 may generate and supply a first power supply voltage ELVDD, a second power supply voltage ELVSS, a reference power supply voltage VREF, and an initialization power supply voltage VINT to the pixel part 140. Further, the power supply 150 may generate voltages VGH and VGL and transfer the voltages VGH and VGL to the scan driver 130 and the emission driver 160.

The pixel part 140 may include a display panel, and the pixel part 140 includes a plurality of pixels. For example, a pixel PXij may be electrically connected to a scan line SLi located on a corresponding horizontal line, an emission control line ECLi, and a data line DLj located on a corresponding vertical line. FIG. 1 illustrates each pixel PXij being connected to one scan line SLi and one emission control line ECLi. However, embodiments are not limited thereto. For example, each horizontal line may be arranged with two or more scan lines or two or more emission control lines to which different scan signals are applied. Each pixel PXij may be electrically connected to the two or more scan lines or two or more emission control lines. The pixel PXij may be supplied with the first power supply voltage ELVDD, the second power supply voltage ELVSS, and the reference power supply voltage VREF.

The signal lines connected to the pixels PXij of the pixel part 140, and the driving signals and the driving voltages supplied from the power lines are not limited to the above-described embodiments, and may be varied.

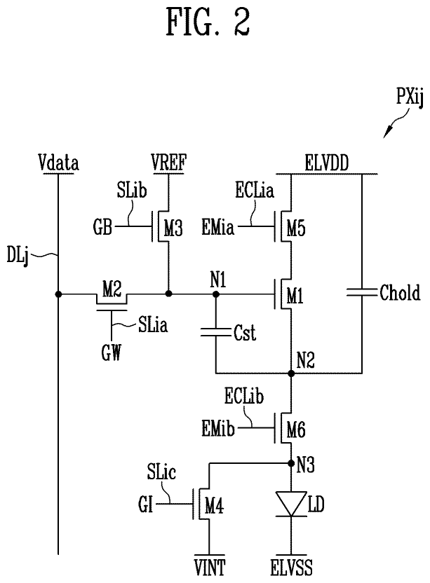

FIG. 2 is a schematic illustrating aspects of the pixel shown in FIG. 1 according to some embodiments. Although FIG. 2 illustrates various components in a pixel according to some embodiments, embodiments according to the present disclosure are not limited thereto, and according to various embodiments, the pixel may include additional components, or fewer components, without departing from the spirit and scope of embodiments according to the present disclosure.

Referring to FIG. 2, the pixel PXij may be connected to at least one scan line and emission control line located on a corresponding horizontal line, and to a data line DLj located on a corresponding vertical line. For example, the pixel PXij may be connected to a first scan line SLia, a second scan line SLib, and a third scan line SLic of the corresponding horizontal line, a first emission control line ECLia, a second emission control line ECLib of the corresponding horizontal line, and the data line DLj of the corresponding vertical line.

The pixel PXij may include a first transistor M1 (also referred to as a “driving transistor”), a second transistor M2 (also referred to as a “first switching transistor”), and a first capacitor Cst (also referred to as a “storage capacitor”). According to some embodiments, the pixel PXij may include a third transistor M3 (also referred to as a “second switching transistor”), a fourth transistor M4 (also referred to as a “third switching transistor”), a fifth transistor M5 (also referred to as a “fourth switching transistor”), a sixth transistor M6 (also referred to as a “fifth switching transistor”), and a second capacitor Chold (also referred to as a “holding capacitor”). The pixel PXij may further include a light emitting element LD.

The pixel PXij may be driven by driving signals and driving voltages. The driving signals may include a first scan signal GW, a second scan signal GB, a third scan signal GI, a first emission control signal EMia, a second emission control signal EMib, and a data signal (e.g., a data voltage Vdata). The driving voltages may include the first power supply voltage ELVDD, the second power supply voltage ELVSS, the reference power supply voltage VREF, and the initialization power supply voltage VINT.

The first transistor M1 may be connected between the first power supply voltage ELVDD and a second node N2. For example, a first electrode of the first transistor M1 may be connected to the first power supply voltage ELVDD through the fifth transistor M5, and the second electrode of the first transistor M1 may be connected to the second node N2.

The second node N2 may be a node to which a second electrode of the first transistor M1 and a first electrode of the sixth transistor M6 are connected in common. A gate electrode of the first transistor M1 may be connected to a first node N1.

The first transistor M1 may supply a driving current to the light emitting element LD. For example, the first transistor M1 may supply a driving current corresponding to a voltage of the first node N1 to the light emitting element LD through the sixth transistor M6.

According to some embodiments, the first transistor M1 may further include a bottom gate to relatively improve its operating characteristics. For example, the bottom gate of the first transistor M1 may be connected to the second node N2.

The second transistor M2 may be connected between the data line DLj and the first node N1. A gate electrode of the second transistor M2 may be connected to the first scan line SLia.

The second transistor M2 may be turned on in response to the first scan signal GW supplied to the first scan line SLia. When the second transistor M2 is turned on, a data signal supplied by the data line DLj may be transferred to the first node N1.

The third transistor M3 may be connected between the reference power supply voltage VREF and the first node N1. A gate electrode of the third transistor M3 may be connected to the second scan line SLib. The third transistor M3 may be turned on in response to a second scan signal GB supplied to the second scan line SLib. When the third transistor M3 is turned on, the reference power supply voltage VREF may be transferred to the first node N1.

The fourth transistor M4 may be connected between a third node N3 and the initialization power supply voltage VINT. A gate electrode of the fourth transistor M4 may be connected to the third scan line SLic. The fourth transistor M4 may be turned on in response to a third scan signal GI supplied to the third scan line SLic. When the fourth transistor M4 is turned on, the initialization power supply voltage VINT may be transferred to the third node N3. The third node N3 may be a node to which a second electrode of the sixth transistor M6, a first electrode of the fourth transistor M4, and the first electrode of the light emitting element LD are connected in common.

The fifth transistor M5 may be connected between the first power supply voltage ELVDD and the first transistor M1. A gate electrode of the fifth transistor M5 may be connected to the first emission control line ECLia. The fifth transistor M5 may be turned on or off in response to the first emission control signal EMia supplied to the first emission control line ECLia. When the fifth transistor M5 is turned off, a current path through which a driving current flows in the pixel PXij may be blocked, and accordingly, the driving current may not be supplied to the light emitting element LD.

The sixth transistor M6 may be connected between the second node N2 and the third node N3. A gate electrode of the sixth transistor M6 may be connected to the second emission control line ECLib. The sixth transistor M6 may be turned on or off in response to the second emission control signal EMib supplied to the second emission control line ECLib. When the sixth transistor M6 is turned off, a current path through which a driving current flows in the pixel PXij may be blocked, and accordingly, the driving current may not be supplied to the light emitting element LD.

As shown in FIG. 2, the first to sixth transistors M1 to M6 are N-type transistors, but the present disclosure is not limited thereto. For example, at least one of the first to sixth transistors M1 to M6 may be changed to a P-type transistor. According to the type of each transistor, signal levels (e.g., voltage levels) of the driving signals for controlling the driving of the transistor may be set.

The first capacitor Cst may be connected between the first node N1 and the second node N2. The first capacitor Cst may store a voltage corresponding to a data signal.

The second capacitor Chold may be connected between the first power supply voltage ELVDD and the second node N2. The second capacitor Chold may stabilize the voltage of the second node N2.

The light emitting element LD may be connected between the third node N3 and the second power supply voltage ELVSS. For example, the light emitting element LD may be connected in a forward direction between the third node N3 and the second supply voltage ELVSS. When the light emitting element LD is supplied with a driving current from the first transistor M1, the light emitting element LD may emit light with a luminance corresponding to the driving current.

According to some embodiments, the light emitting element LD may include an organic light emitting diode. According to some embodiments, the light emitting element LD may include at least one inorganic light emitting diode. The type, size, and/or number of light emitting element LD may be varied according to some embodiments.

According to some embodiments, at least one transistor provided in the pixel PXij may be an oxide semiconductor transistor. For example, at least one transistor including the first transistor M1 may be an oxide semiconductor transistor including an oxide semiconductor.

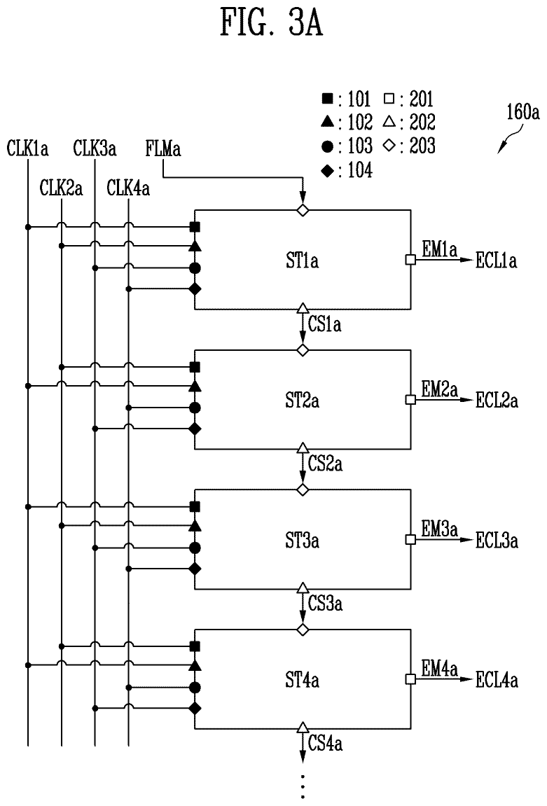

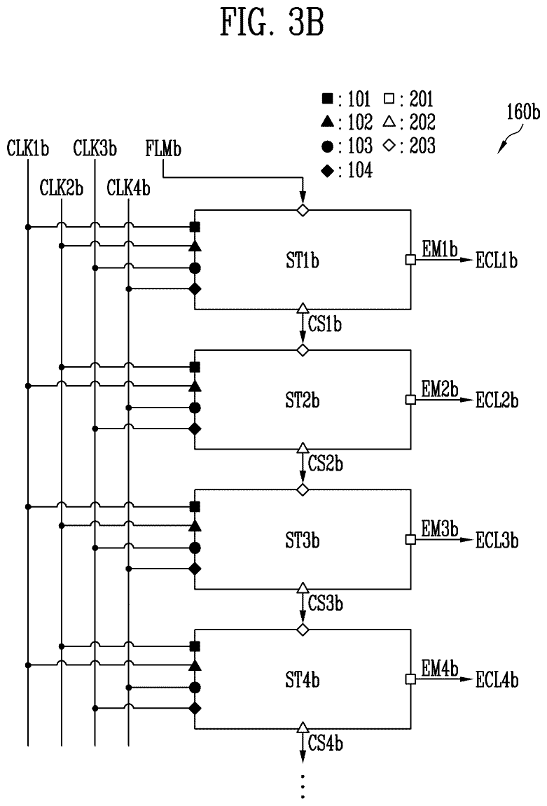

FIG. 3A is a block diagram illustrating a first stage group of the emission driver 160 shown in FIG. 1. FIG. 3B is a block diagram illustrating a second stage group of the emission driver 160 shown in FIG. 1. In the present disclosure, the first stage group and the second stage group included in the emission driver 160 are described mainly. However, the present disclosure is not limited thereto. For example, the present disclosure may be applied to the stages included in the scan driver, and the present disclosure may be applied to the data driver.

FIG. 3A shows a plurality of stages ST1a, ST2a, ST3a, ST4a, . . . included in the first stage group of the emission driver 160 shown in FIG. 1. The first stage group may generate the first emission control signal EMia which is supplied to each of the pixels included in the pixel part 140. That is, the first stage group may generate the first emission control signal EMia which is supplied to each of the pixels included in the pixel PXij.

The plurality of stages ST1a, ST2a, ST3a, ST4a, . . . may include odd-numbered stages ST1a, ST3a, . . . , and even-numbered stages ST2a, ST4a, . . . . The odd-numbered stages ST1a, ST3a, . . . and the even-numbered stages ST2a, ST4a, . . . may be alternately arranged (or connected).

Each of the odd-numbered stages ST1a, ST3a, . . . of the first stage group receives a first clock signal CLK1a through a first input terminal 101, a second clock signal CLK2a through a second input terminal 102, a third clock signal CLK3a through the third input terminal 103, and a fourth clock signal CLK4a through a fourth input terminal 104. Furthermore, each of the odd-numbered stages ST1a, ST3a, . . . of the first stage group receives a previous carry signal or an emission stop signal FLMa through a fifth input terminal 203. The odd-numbered stages ST1a, ST3a, . . . of the first stage group may output first emission control signals EM1a, EM3a, . . . through first output terminals 201 and carry signals CS1a, CS3a, . . . through second output terminals 202, respectively.

Each of the even-numbered stages ST2a, ST4a, . . . of the first stage group receives the second clock signal CLK2a through the first input terminal 101, the first clock signal CLK1a through the second input terminal 102, the fourth clock signal CLK4a through the third input terminal 103, and the third clock signal CLK3a through the fourth input terminal 104. Further, each of the even-numbered stages ST2a, ST4a, . . . of the first stage group receives a previous carry signal through the fifth input terminal 203. The even-numbered stages ST2a, ST4a, . . . of the first stage group may output second emission control signals EM2a, EM4a, . . . through the first output terminals 201, and carry signals CS2a, CS4a, . . . through the second output terminals 202, respectively.

FIG. 3B shows a plurality of stages ST1b, ST2b, ST3b, ST4b, . . . included in the second stage group of the emission driver 160 shown in FIG. 1. The second stage group may generate the second emission control signal EMib which is supplied to each of the pixels included in the pixel part 140. That is, the second stage group may generate the second emission control signal EMib which is supplied to each of the pixels included in the pixel PXij.

The plurality of stages ST1b, ST2b, ST3b, ST4b, . . . may include odd-numbered stages ST1b, ST3b, . . . , and even-numbered stages ST2b, ST4b, . . . . The odd-numbered stages ST1b, ST3b, . . . and the even-numbered stages ST2b, ST4b, . . . may be alternately arranged (or connected).

Each of the odd-numbered stages ST1b, ST3b, . . . of the second stage group receives a first clock signal CLK1b through the first input terminal 101, a second clock signal CLK2b through the second input terminal 102, a third clock signal CLK3b through the third input terminal 103, and a fourth clock signal CLK4b through the fourth input terminal 104. Further, each of the odd-numbered stages ST1b, ST3b, . . . of the second stage group receives a previous carry signal or an emission stop signal FLMb through the fifth input terminal 203. The odd-numbered stages ST1b, ST3b, . . . of the second stage group may output first emission control signals EM1b, EM3b, . . . through the first output terminal 201 and carry signals CS1b, CS3b, . . . through the second output terminal 202.

Each of the even-numbered stages ST2b, ST4b, . . . of the second stage group receives the second clock signal CLK2b through the first input terminal 101, receives the first clock signal CLK1b through the second input terminal 102, receives the fourth clock signal CLK4b through the third input terminal 103, and receives the third clock signal CLK3b through the fourth input terminal 104. Further, each of the even-numbered stages ST2b, ST4b, . . . of the second stage group receives a previous carry signal through the fifth input terminal 203. The even-numbered stages ST2b, ST4b, . . . of the second stage group may output second emission control signals EM2b, EM4b, . . . through the first output terminals 201, and carry signals CS2b, CS4b, . . . through the second output terminals 202, respectively.

In FIG. 3A, the plurality of stages ST1a, ST2a, ST3a, ST4a, . . . included in the first stage group may have substantially the same circuit configurations. In FIG. 3B, the plurality of stages ST1b, ST2b, ST3b, ST4b, . . . included in the second stage group may also have substantially the same circuit configurations. Furthermore, the circuit configuration of one of the plurality of stages ST1a, ST2a, ST3a, ST4a, . . . included in the first stage group may be substantially identical to the circuit configuration of one of the plurality of stages ST1b, ST2b, ST3b, ST4b, . . . included in the second stage group. An example circuit diagram of one of the plurality of stages included in the first stage group will be described below.

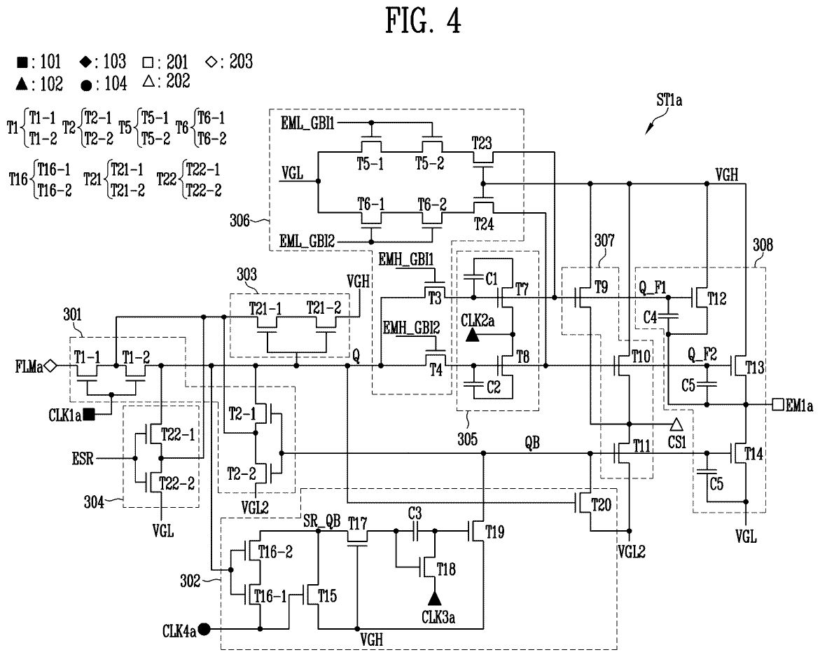

FIG. 4 is a schematic illustrating aspects of one of the plurality of stages shown in FIG. 3A according to some embodiments. Although FIG. 4 illustrates various components in a stage according to some embodiments, embodiments according to the present disclosure are not limited thereto, and according to various embodiments, the stage may include additional components, or fewer components, without departing from the spirit and scope of embodiments according to the present disclosure.

Referring to FIG. 4, the stage ST1a according to some embodiments of the present disclosure may include a first node voltage setting portion 301, a second node voltage setting portion 302, a leakage current blocking portion 303, a reset portion 304, a voltage boosting portion 305, a path selecting portion 306, a carry signal output portion 307, and a light-emitting signal output portion 308. The first stage ST1a of the first stage group is described as an example, but the other stages ST2a, ST3a, ST4a, . . . of the first stage group may have the same structure. Furthermore, the plurality of stages ST1b, ST2b, ST3b, ST4b, . . . included in the second stage group may also have the same structure as the stage ST1a shown in FIG. 4. However, as described with reference to FIG. 4, the signals input to the input terminals (101, 102, 103, and 104) may differ between the stages ST1a, ST2a, ST3a, ST4a, . . . of the first stage group and the stages ST1b, ST2b, ST3b, ST4b, . . . of the second stage group.

The first node voltage setting portion 301 may set a voltage of a first node Q based on a previous carry signal (or the emission stop signal FLMa), a voltage of a second node QB, and the first clock signal CLK1a. The first node voltage setting portion 301 may include a first transistor T1 and a second transistor T2. The first transistor T1 may include sub-transistors T1-1 and T1-2 connected in series. The second transistor T2 may include the sub-transistors T2-1 and T2-2 connected in series.

The first transistor T1 may have a first electrode connected to the third input terminal 103, a second electrode connected to the first node Q, and a gate electrode connected to the first input terminal 101. The second transistor T2 may have a first electrode connected to the first node Q, a second electrode receiving a third voltage VGL, and a gate electrode connected to the second node QB.

The second node voltage setting portion 302 may set a voltage of the second node QB based on the voltage of the first node Q, the third clock signal CLK3a, and the fourth clock signal CLK4a. The second node voltage setting portion 302 may include a 15th transistor T15, a 16th transistor T16, a 17th transistor T17, an 18th transistor T18, a 19th transistor T19, and a third capacitor C3. The 16th transistor T16 may include sub-transistors T16-1 and T16-2 connected in series.

The 15th transistor T15 may have a first electrode connected to a node SR_QB, a second electrode receiving the first voltage VGH, and a gate electrode connected to the fourth input terminal 104. The 16th transistor T16 may have a first electrode connected to the node SR_QB, a second electrode connected to the fourth input terminal 104, and a gate electrode connected to the first node Q. The 17th transistor T17 may have a first electrode connected to the node SR_QB, a second electrode connected to a first electrode of the third capacitor C3, and a gate electrode receiving the first voltage VGH. The 18th transistor T18 may have a first electrode connected to a second electrode of the third capacitor C3, a second electrode connected to the third input terminal 103, and a gate electrode connected to the first electrode of the third capacitor C3. The 19th transistor T19 may have a first electrode connected to the second node QB, a second electrode receiving the first voltage VGH, and a gate electrode connected to the first electrode of the 18th transistor T18. The third capacitor C3 may be connected between the gate electrode and the first electrode of the 18th transistor T18.

The leakage current blocking portion 303 may block a leakage current path connected to the first node Q, based on the voltage of the first node Q. The leakage current path may be located in the first node voltage setting portion 301. Further, the leakage current path may be located in the reset portion 304. For example, the leakage current path may include a path between the first electrode and the second electrode of the first transistor T1, a path between the first electrode and the second electrode of the second transistor T2, and a path between a first electrode and a second electrode of a 22nd transistor T22. The leakage current blocking portion 303 supplies the first voltage VGH between the sub-transistors T1-1 and T1-2 of the first transistor T1 when the first node Q is at a logic high level, and supplies the first voltage VGH between the sub-transistors T2-1 and T2-2 of the second transistor T2 when the first node Q is at a logic low level, and supplies the first voltage VGH between sub-transistors T22-1 and T22-2 of the 22nd transistor T22, thereby blocking the leakage current from flowing from the first node Q and allowing the first node Q to maintain a logic high level. The leakage current blocking portion 303 may include a 21st transistor T21. The 21st transistor T21 may include sub-transistors T21-1 and T21-2 connected in series.

The 21st transistor T21 has a first electrode connected to a node between the sub-transistors T1-1 and T1-2 of the first transistor T1, a node between the sub-transistors T2-1 and T2-2 of the second transistor T2, and a node between the sub-transistors T22-1 and T22-2 of the 22nd transistor T22, a second electrode receiving the first voltage VGH, and a gate electrode connected to the first node Q.

The reset portion 304 may reset the voltage of the first node Q based on a reset signal ESR. The reset portion 304 may include the 22nd transistor T22. The 22nd transistor T22 may include the series-connected sub-transistors T22-1 and T22-2. The first electrode of the 22nd transistor T22 may be connected to the first node Q, the second electrode may receive the third voltage VGL, and a gate electrode thereof may receive the reset signal ESR.

The path selecting portion 306 may select at least one of two or more paths between the first node Q and the carry signal output portion 307 (or the light-emitting signal output portion 308) and may conduct current through the selected path. The two or more paths may include a path including a node Q_F1 and a path including a node Q_F2. As the path selecting portion 306 selects and uses different paths in units of frames, stress on the transistors located on each path may be relieved. According to some embodiments, the path selecting portion 306 may simultaneously select and use the path including the node Q_F1 and the path including the node Q_F2.

The path selecting portion 306 may include a third transistor T3, a fourth transistor T4, a fifth transistor T5, a sixth transistor T6, a 23rd transistor T23, and a 24th transistor T24. The fifth transistor T5 may include sub-transistors T5-1 and T5-2 connected in series. The sixth transistor T6 may include sub-transistors T6-1 and T6-2 connected in series.

The third transistor T3 may have a first electrode connected to the first node Q, a second electrode connected to the node Q_F1, and a gate electrode receiving a path selection signal EMH_GBI1. The fourth transistor T4 may have a first electrode connected to the first node Q, a second electrode connected to the node Q_F2, and a gate electrode receiving a path selection signal EMH_GBI2. The fifth transistor T5 may have a first electrode receiving the third voltage VGL, a second electrode connected to a first electrode of the 23rd transistor T23, and a gate electrode receiving a path selection signal EML_GBI1. A logic level of the path selection signal EML_GBI1 may be opposite to a logic level of the path selection signal EMH_GBI1. The sixth transistor T6 may include a first electrode receiving the third voltage VGL, a second electrode connected to a first electrode of the 24th transistor T24, and a gate electrode including a path selection signal EML_GBI2. A logic level of the path selection signal EML_GBI2 may be opposite to a logic level of the path selection signal EMH_GBI2. The 23rd transistor T23 may have the first electrode connected to the second electrode of the fifth transistor T5, a second electrode connected to the node Q_F1, and a gate electrode receiving the first voltage VGH. The 24th transistor T24 may have the first electrode connected to the second electrode of the sixth transistor T6, a second electrode connected to the node Q_F2, and a gate electrode receiving the first voltage VGH.

The voltage boosting portion 305 may boost a voltage of the path selected by the path selecting portion 306 based on the second clock signal CLK2a. The voltage boosting portion 305 may include a seventh transistor T7, an eighth transistor T8, a first capacitor C1, and a second capacitor C2.

The seventh transistor T7 may have a first electrode connected to a first electrode of the first capacitor C1, a second electrode connected to the second input terminal 102, and a gate electrode connected to the node Q_F1. The eighth transistor T8 may have a first electrode connected to the second input terminal 102, a second electrode connected to a second electrode of the second capacitor C2, and a gate electrode connected to the node Q_F2. The first capacitor C1 may be connected between the gate electrode and the first electrode of the seventh transistor T7. The second capacitor C2 may be connected between the gate electrode and the second electrode of the eighth transistor T8.

The carry signal output portion 307 may output a carry signal CS1 at a turn-on level based on the voltage of the first node Q, and may output the carry signal CS1 at a turn-off level based on the voltage of the second node QB. The carry signal output portion 307 may include a ninth transistor T9, a 10th transistor T10, and an 11th transistor T11.

The ninth transistor T9 may have a first electrode receiving the first voltage VGH, a second electrode connected to the second output terminal 202, and a gate electrode connected to the node Q_F1. The 10th transistor T10 may have a first electrode receiving the first voltage VGH, a second electrode connected to the second output terminal 202, and a gate electrode connected to the node Q_F2. The 11th transistor T11 may have a first electrode connected to the second output terminal 202, a second electrode receiving a second voltage VGL2, and a gate electrode connected to the second node QB.

The light-emitting signal output portion 308 may output the first emission control signal EM1a at a turn-on level based on the voltage of the first node Q, and may output the first emission control signal EM1a at a turn-off level based on the voltage of the second node QB. The light-emitting signal output portion 308 may include a 12th transistor T12, a 13th transistor T13, a 14th transistor T14, a fourth capacitor C4, a fifth capacitor C5, and a sixth capacitor C6.

The 12th transistor T12 may have a first electrode receiving the first voltage VGH, a second electrode connected to the first output terminal 201, and a gate electrode connected to the node Q_F1. The fourth capacitor C4 may be connected between the gate electrode and the second electrode of the 12th transistor T12. The 13th transistor T13 may have a first electrode receiving the first voltage VGH, a second electrode connected to the first output terminal 201, and a gate electrode connected to the node Q_F2. The fifth capacitor C5 may be connected between the gate electrode and the second electrode of the 13th transistor T13. The 14th transistor T14 may have a first electrode connected to the first output terminal 201, a second electrode receiving the third voltage VGL, and a gate electrode connected to the second node QB. The sixth capacitor C6 may be connected between the gate electrode and the second electrode of the 14th transistor T14.

However, the circuit diagram shown in FIG. 4 is an example and the present disclosure is not limited thereto. In other words, various circuit diagrams different from that shown in FIG. 4 may configure the stage ST1a according to the present disclosure.

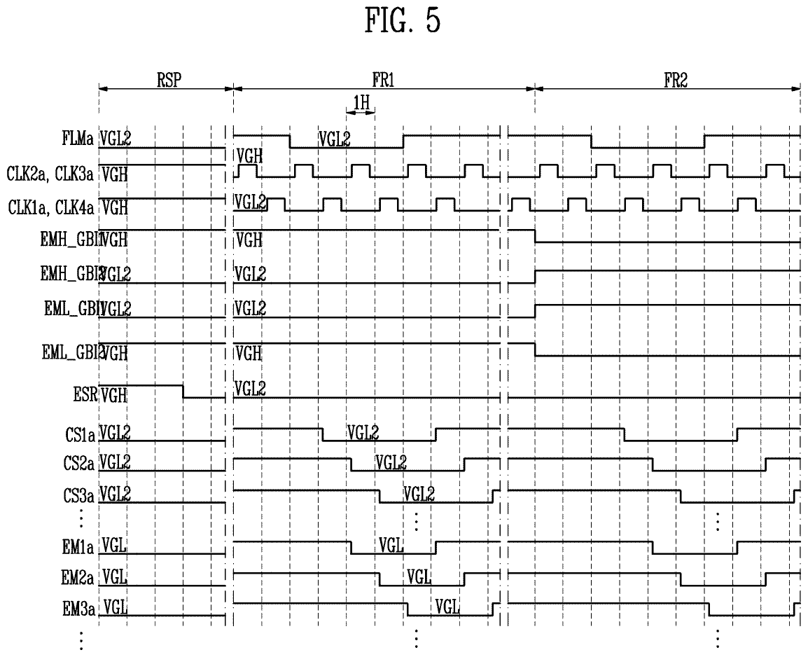

FIG. 5 is a diagram illustrating the overall operation of the first stage group shown in FIG. 3A. Referring to FIG. 5, during a reset period RSP, for example, when the display device 100 is powered on, the reset signal ESR at a turn-on level may be supplied to the plurality of stages ST1a, ST2a, ST3a, ST4a, . . . . The turn-on level of the reset signal ESR may correspond to the first voltage VGH, and a turn-off level of the reset signal ESR may correspond to the second voltage VGL2. In FIG. 5, the reset signal ESR may maintain the turn-on level for a period (e.g., a set or predetermined period) of time (e.g., for three horizontal periods) and then maintain the turn-off level.

During the reset period RSP, the emission stop signal FLMa may be maintained at a turn-off level (e.g., the second voltage VGL2), and the first, second, third, and fourth clock signals CLK1a, CLK2a, CLK3a, and CLK4a may be maintained at a turn-on level (e.g., the first voltage VGH). Accordingly, the first node Q of all the stages ST1a, ST2a, ST3a, ST4a, . . . may be maintained at a turn-off level during the reset period RSP, and the carry signals CS1a, CS2a, CS3a, . . . and the emission control signals EM1a, EM2a, EM3a, . . . may be maintained at a turn-off level.

For example, the path selection signals EMH_GBI1 and EML_GBI2 may be set to a turn-on level (e.g., the first voltage VGH) and the path selection signals EMH_GBI2 and EML_GBI1 may be set to a turn-off level (e.g., the second voltage VGL2). In another example, the path selection signals EMH_GBI2 and EML_GBI1 may be set to a turn-on level (e.g., the first voltage VGH) and the path selection signals EMH_GBI1 and EML_GBI2 may be set to a turn-off level (e.g., the second voltage VGL2). In another example, the path selection signals EMH_GBI1 and EMH_GBI2 may be set to a turn-on level and the path selection signals EML_GBI1 and EML_GBI2 may be set to a turn-off level. In this manner, the path selection signals EMH_GBI1, EMH_GBI2, EML_GBI1, and EML_GBI2 may be set relatively freely.

During a plurality of frame periods FR1 and FR2 after the reset period RSP, the reset signal ESR may remain at the turn-off level.

During the plurality of frame periods FR1 and FR2, the first clock signal CLK1a and the second clock signal CLK2a may have the same cycle but different phases. For example, the first, second, third, and fourth clock signals CLK1a, CLK2a, CLK3a, and CLK4a may have a cycle of two horizontal periods. The first clock signal CLK1a and the fourth clock signal CLK4a may have the same phase, and second clock signal CLK2a and the third clock signal CLK3a may have the same phase. On the other hand, the phases of the first and fourth clock signals CLK1a and CLK4a may be 180 degrees different from the phases of the second and third clock signals CLK2a and CLK3a. For example, the first, second, third, and fourth clock signals CLK1a, CLK2a, CLK3a, and CLK4a may include pulses at the turn-on level of approximately one horizontal period 1H in length, while the pulses of the first and fourth clock signals CLK1a and CLK4a and the second and third clock signals CLK2a and CLK3a may not overlap each other. The turn-on level of each of the first, second, third, and fourth clock signals CLK1a, CLK2a, CLK3a, and CLK4a may correspond to the first voltage VGH, and the turn-off level of each of the first, second, third, and fourth clock signals CLK1a, CLK2a, CLK3a, and CLK4a may correspond to the second voltage VGL2.

The emission stop signal FLMa may maintain the turn-on level for a majority of the duration of each frame period, and may include a pulse of the turn-off level at the beginning of each frame period. As shown in FIG. 5, the length of the pulse at the turn-off level corresponds to four horizontal periods. However, the length of the pulse may vary according to embodiments. The turn-on level of the emission stop signal FLMa may correspond to the first voltage VGH, and the turn-off level of the emission stop signal FLMa may correspond to the second voltage VGL2.

The turn-on level of each of the path selection signals EMH_GBI1, EMH_GBI2, EML_GBI1, and EML_GBI2 may correspond to the first voltage VGH, and the turn-off level of each of the path selection signals EMH_GBI1, EMH_GBI2, EML_GBI1, and EML_GBI2 may correspond to the second voltage VGL2.

According to some embodiments, logic levels of the path selection signals EMH_GBI1, EMH_GBI2, EML_GBI1, and EML_GBI2 may be inverted on a frame period basis. For example, during the first frame period FR1, the path selection signal EMH_GBI1 may be at a logic high level and the path selection signal EMH_GBI2 may be at a logic low level. During the second frame period FR2, the path selection signal EMH_GBI1 may be at a logic low level and the path selection signal EMH_GBI2 may be at a logic high level. As described above, the path selection signal EML_GBI1 may have a logic level opposite to the path selection signal EMH_GBI1. Further, the path selection signal EML_GBI2 may be at a logic level opposite to the path selection signal EMH_GBI2. Referring to FIGS. 4 and 5, during the first frame period FR1, the path through the node Q_F1 is activated and the path through the node Q_F2 is deactivated. Further, during the second frame period FR2, the path through the node Q_F1 may be deactivated and the path through the node Q_F2 may be activated. Accordingly, the stress on the transistors in the deactivated path may be relatively reduced.

According to some embodiments, the path selection signals EMH_GBI1 and EMH_GBI2 may be maintained at a logic high level for a plurality of consecutive frame periods FR1, FR2, . . . . During the plurality of consecutive frame periods FR1, FR2, . . . , the path selection signals EML_GBI1 and EML_GBI2 may be maintained at a logic low level. According to some embodiments, a path through the plurality of nodes Q_F1 and Q_F2 may be activated during the plurality of consecutive frame periods FR1, FR2, . . . .

During each of the frame periods FR1, FR2, . . . , the stages ST1a, ST2a, ST3a, ST4a, . . . may sequentially output the carry signals CS1a, CS2a, CS3a, . . . at the turn-off level and the emission control signals EM1a, EM2a, EM3a, . . . . The turn-on level of the carry signals CS1a, CS2a, CS3a, . . . may correspond to the first voltage VGH, and the turn-off level of the carry signals CS1a, CS2a, CS3a, . . . may correspond to the second voltage VGL2. The turn-on level of the emission control signals EM1a, EM2a, EM3a, . . . may correspond to the first voltage VGH, and the turn-off level of the emission control signals EM1a, EM2a, EM3a, . . . may correspond to the third voltage VGL.

According to some embodiments, the third voltage VGL may be greater than the second voltage VGL2. Both the second voltage VGL2 and the third voltage VGL correspond to logic low levels. According to embodiments, the third voltage VGL may be the same as the second voltage VGL2.

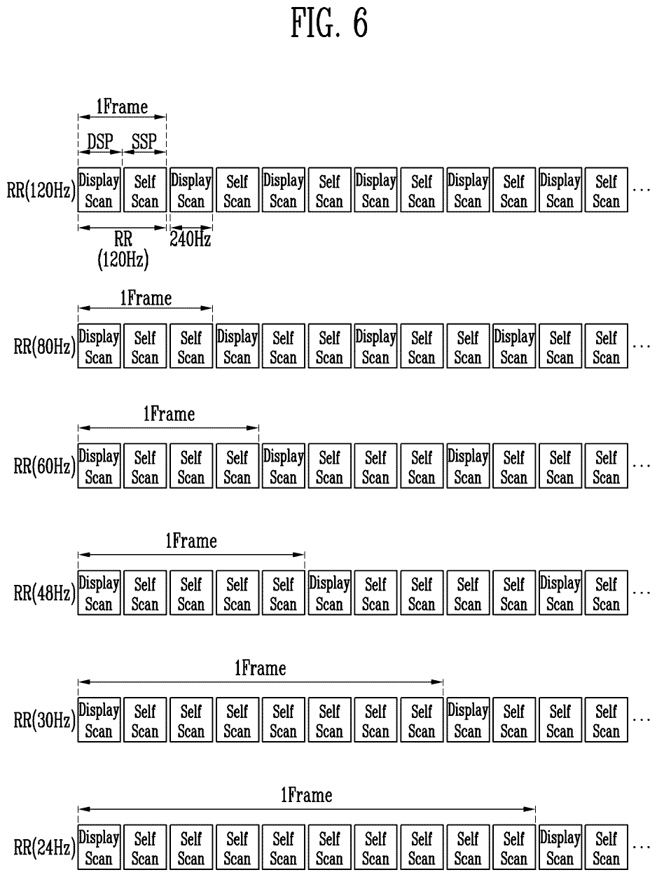

The timing diagram shown in FIG. 5 illustrates operations of the first stage group included in the emission driver 160 during a display scan period DSP. Operations of the emission driver 160 during a self-scan period SSP may differ from those shown in the timing diagram shown in FIG. 5. The display scan period DSP and self-scan period DSP are described with reference to FIG. 6.

FIG. 6 is a conceptual diagram illustrating one example of a method of driving a display device according to a video refresh rate. When the display device 100 supports variable frequency driving, the display device 100 may display video at different frame rates. One frame period at each frame rate may include at least one display scan period DSP and at least one self-scan period DSP.

According to some embodiments, the length of the display scan period DSP and the length of the self-scan period SSP may be substantially the same. However, the number of self-scan periods SSP included in one frame period may be determined by the video refresh rate RR.

As shown in FIG. 6, when the display device 100 operates at the video refresh rate RR of 120 Hz, one frame period may include one display scan period DSP and one self-scan period SSP. Accordingly, when the display device 100 operates at the video refresh rate RR of 120 Hz, the pixels PX may alternate between emission and non-emission twice each during one frame period.

Further, when the display device 100 operates at the video refresh rate RR of 80 Hz, one frame period may include one display scan period DSP and two consecutive self-scan periods SSP. Accordingly, when the display device 100 operates at the video refresh rate RR of 80 Hz, the pixels PX may alternate between emission and non-emission three times each during one frame period.

Similarly, the display device 100 may operate at a driving frequency of 60 Hz, 48 Hz, 30 Hz, 24 Hz, 1 Hz, or the like by adjusting the number of self-scan periods SSP included in one frame period. In other words, the display device 100 may support various video refresh rates RR with frequencies corresponding to divisors of a first frequency. Further, the number of self-scan periods SSP increases as the driving frequency decreases, so that an on-bias and/or an off-bias of a magnitude (e.g., a set or predetermined magnitude) may be periodically applied to each of the first transistors M1 included in the pixel PXij. Thus, luminance reduction, flickering, and screen dragging at low-frequency driving may be alleviated.

During the display scan period DSP and the self-scan period SSP, the pixels may operate in different manners. Accordingly, different driving signals may be supplied to the pixels during the display scan period DSP and the self-scan period SSP. For example, the first scan signal GW supplied to the pixel PXij may vary during the display scan period DSP, while the first scan signal GW supplied to the pixel PXij may not vary during the self-scan period SSP. On the other hand, the first emission control signal EMia supplied to the pixel PXij during the display scan period DSP and the self-scan period SSP may vary.

The characteristics of the driving signals supplied to the pixel PXij of FIG. 2 during the display scan period DSP and the self-scan period SSP are shown below in [Table 1].

TABLE 1

| | GW | GB | GI | EMia | EMib |
|---|---|---|---|---|---|
| DSP | AC | AC | AC | AC | AC |
| SSP | DC | DC | DC | DC | DC |

In [Table 1], during the display scan period DSP or the self-scan period SSP, driving signals are denoted as “AC” when the driving signals are changed, and denoted as “DC” when the driving signals do not change. In other words, referring to [Table 1], during the display scan period DSP, first, second, and third scan signals GW, GB, and GI may all change to write data to the storage capacitor Cst to turn on or off the second, third, and fourth transistors M2, M3, and M4 at required times, respectively. On the other hand, during the self-scan period SSP, because no write operation is performed on the storage capacitor Cst, the first, second, and third scan signals GW, GB, and GI may all remain unchanged. In other words, during the self-scan period SSP, the first, second, and third scan signals GW, GB, and GI may maintain a voltage corresponding to the turn-off level of the transistors.

Referring to [Table 1], first and second emission control signals EMia and EMib may change during the display scan period DSP. For example, the fifth transistor M5 or the sixth transistor M6 may be turned off while the write operation is performed on the storage capacitor Cst, and the fifth transistor M5 or the sixth transistor M6 may be turned on during a light emitting operation. Accordingly, the first and second emission control signals EMia and EMib may be changed during the display scan period DSP in order to turn off or on the fifth transistor M5 or the sixth transistor M6 at an appropriate time. On the other hand, during the self-scan period SSP, the first and second emission control signals EMia and EMib may not change because no write operation is performed on the storage capacitor Cst. In other words, during the self-scan period SSP, the first and second emission control signals EMia and EMib may maintain a voltage corresponding to the turn-on level of the transistor.

The stages included in the scan driver generating the first, second, and third scan signals GW, GB, and GI may generate a voltage corresponding to the turn-off level during the self-scan period SSP as described above. Thus, the clock signals which are input to the stages included in the scan driver may not change during the self-scan period SSP, and may maintain a voltage at a high level or a low level.

However, the stages included in the emission driver generating the first and second emission control signals EMia and EMib, it is necessary to generate a voltage corresponding to the turn-on level during the self-scan period SSP as described above. In the stage ST1a as shown in FIG. 4, it is necessary to maintain some node voltages therein to maintain the voltage of the first emission control signal EMia corresponding to the turn-on level. For example, the second clock signal CLK2a which is continuously toggling is required to be input so as to maintain the voltage of the node Q_F1. When the voltage of the second clock signal CLK2a is maintained (DC), the voltage of the node Q_F1 will fall over time, and the voltage of the first emission control signal EMia may not be maintained accordingly. Therefore, the second clock signal CLK2a may be continuously changed to maintain the voltage of the node Q_F1. However, it the first clock signal CLK1a or the third clock signal CLK3a may not change.

In other words, at least one of the stages included in the emission driver may need to receive a clock signal which changes during the self-scan period SSP. However, when all of the clock signals which are input to the stages during the self-scan period SSP are changed, this may cause an increase in the power consumed by the display device 100. As described above, except for clock signals which require changes to maintain the voltage of some nodes in the stage, other clock signals may be controlled so as not to be changed during the self-scan period SSP, thereby relatively reducing power consumption of the display device 100.

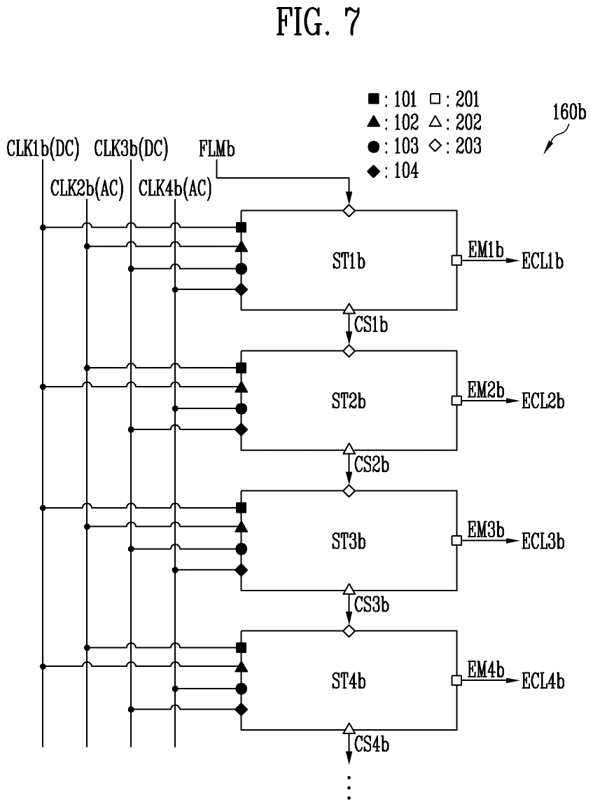

FIG. 7 is a block diagram illustrating the operation of the second stage group according to some embodiments of the present disclosure during a self-scan period. Hereinafter, embodiments are described below with respect to the first stage group and the second stage group included in the emission driver. However, the present disclosure is not limited thereto. For example, the present disclosure may be applied to stages included in the scan driver and may also be applied to the data driver.

FIG. 7 shows clock signals applied to the stages of the second stage group during the self-scan period SSP. For example, the first and third clock signals CLK1b and CLK3b which do not change and the second and fourth clock signals CLK2b and CLK4b which change during the self-scan period SSP may be applied to the first stage ST1b of the second stage group. In FIG. 7, the first and third clock signals CLK1b and CLK3b which do not change are denoted as “DC,” and the second and fourth clock signals CLK2b and CLK4b which change are denoted as “AC.” A second emission control signal of a turn-on level applied to the gate of the sixth transistor M6 as shown in FIG. 2 may be output from the stages included in the second stage group. Also, according to some embodiments, the first, second, third, and fourth clock signals CLK1b, CLK2b, CLK3b, and CLK4b which change (AC) may be applied to the stages of the second stage group during the display scan period DSP.

FIG. 7 illustrates embodiments in which the first and third clock signals CLK1b and CLK3b which do not change and the second and fourth clock signals CLK2b and CLK4b which change may be applied to the first stage ST1b of the second stage group during the self-scan period SSP. However, the present disclosure is not limited thereto. For example, each of the plurality of stages in the first stage group may receive at least one clock signal which does not change during the self-scan period SSP and at least one clock signal which changes during the changing self-scan period SSP.

In other words, according to a display device according to some embodiments of the present disclosure, at least one stage of the plurality of stages included in the emission driver may receive clock signals of the first group and clock signals of the second group. In the embodiments of FIG. 7, the clock signals of the first group may be the first and third clock signals CLK1b and CLK3b, and the clock signals of the second group may be the second and fourth clock signals CLK2b and CLK4b. According to some embodiments of the present disclosure, during the display scan period DSP of the display device, the clock signals of the first and second groups may all have changing voltage values. During the self-scan period SSP of the display device, the clock signals of the first group may have unchanging voltage values, and the clock signals of the second group may have changing voltage values.

That is, at least one stage of the plurality of stages included in the emission driver may receive clock signals through the input terminals of the first group and the input terminals of the second group. In the embodiments of FIG. 7, the input terminals of the first group of the first stage ST1b may be the first and third input terminals 101 and 103. Further, the input terminals of the second group of the first stage ST1b may be the second and fourth input terminals 102 and 104. According to some embodiments of the present disclosure, during the display scan period DSP of the display device, clock signals having changing voltage values may be applied through the input terminals of the second group of the first stage. During the self-scan period SSP of the display device, signals of a DC component with unchanging voltage values may be input through the input terminals of the first group, and clock signals of an AC component with changing voltage values may be input through the input terminals of the second group.

In the embodiments of FIG. 7, the first, second, third, and fourth clock signals CLK1b, CLK2b, CLK3b, and CLK4b may be applied from pads dedicated to the second stage group. However, the present disclosure is not limited thereto, and the changing (AC) clock signals applied to the second stage group in the emission driver may be supplied in common with the clock signals applied to the first stage group in the emission driver or the clock signals applied to the stages included in the scan driver.

As shown in FIG. 7, in a display device according to some embodiments of the present disclosure, during the self-scan period SSP, at least one clock signal of the plurality of clock signals supplied to the stages included in the emission driver changes, while at least another clock signal does not change. Thus, the power consumption of the display device 100 is relatively reduced.

The embodiments have been described with respect to the first stage group and the second stage group included in the emission driver with reference to FIG. 7. However, the present disclosure is not limited thereto. For example, the present disclosure may be applied to the stages included in the scan driver, and the present disclosure may also be applied to the data driver.

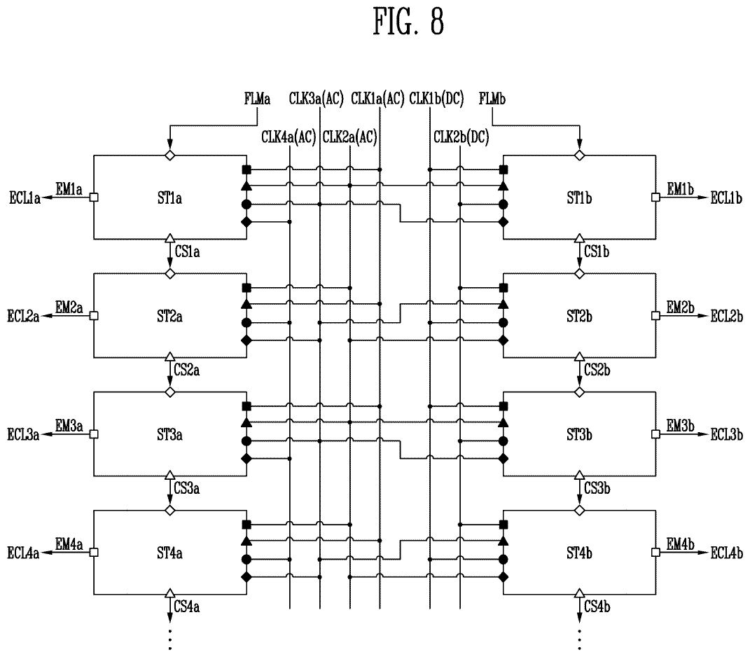

FIG. 8 is a block diagram illustrating the operation of a second stage group according to some embodiments of the present disclosure during a self-scan period. FIG. 8 shows both stages of the first stage group and states of the second stage group of the emission driver. For example, FIG. 8 illustrates the plurality of stages ST1a, ST2a, ST3a, ST4a, . . . included in the first stage group of the emission driver and the plurality of stages ST1b, ST2b, ST3b, ST4b, . . . included in the second stage group of the emission driver.

Similarly to FIG. 3A, each of the odd-numbered stages ST1a, ST3a, . . . of the first stage group receives the first clock signal CLK1a through the first input terminal 101, the second clock signal CLK2a through the second input terminal 102, the third clock signal CLK3a through the third input terminal 103, and the fourth clock signal CLK4a through the fourth input terminal 104. Furthermore, each of the odd-numbered stages ST1a, ST3a, . . . of the first stage group receives a previous carry signal or the emission stop signal FLMa through the fifth input terminal 203. The odd-numbered stages ST1a, ST3a, . . . of the first stage group may output the first emission control signals EM1a, EM3a, . . . through the first output terminals 201 and the carry signals CS1a, CS3a, . . . through the second output terminals 202, respectively.

Further, each of the odd-numbered stages ST1b, ST3b, . . . of the second stage group receives the first clock signal CLK1b through the first input terminal 101, the second clock signal CLK2a through the second input terminal 102, the second clock signal CLK2b through the third input terminal 103, and the third clock signal CLK3a through the fourth input terminal 104. Furthermore, each of the odd-numbered stages ST1b, ST3b, . . . of the second stage group receives a previous carry signal or the emission stop signal FLMb through the fifth input terminal 203. The odd-numbered stages ST1b, ST3b, . . . of the second stage group may output the first emission control signals EM1b, EM3b, . . . through the first output terminal 201 and the carry signals CS1b, CS3b, . . . through the second output terminal 202.

Each of the even-numbered stages ST2b, ST4b, . . . of the second stage group receives the second clock signal CLK2b through the first input terminal 101, receives the third clock signal CLK3a through the second input terminal 102, receives the first clock signal CLK1b through the third input terminal 103, and receives the second clock signal CLK2a through the fourth input terminal 104. Further, each of the even-numbered stages ST2b, ST4b, . . . of the second stage group receives a previous carry signal through the fifth input terminal 203. The even-numbered stages ST2b, ST4b, . . . of the second stage group may output the second emission control signals EM2b, EM4b, . . . through the first output terminals 201, and the carry signals CS2b, CS4b, . . . through the second output terminals 202, respectively.

As shown in FIG. 8, the first, second, third, and fourth clock signals CLK1a, CLK2a, CLK3a, and CLK4a corresponding to the first stage group may change during the self-scan period SSP (AC), and the first and second clock signals CLK1b and CLK2b corresponding to the second stage group may not change during the self-scan period SSP (DC). In the embodiments of FIG. 8, the first and second clock signals CLK1b and CLK2b which do not change during the self-scan period SSP may be applied from pads dedicated to the second stage group, respectively. On the other hand, the second and third clock signals CLK2a and CLK3a corresponding to the first stage group may be commonly applied to the second stage group.

As shown in FIG. 8, in a display device according to some embodiments of the present disclosure, during the self-scan period SSP, at least one clock signal of the plurality of clock signals supplied to the stages included in the emission driver changes, while at least another clock signal does not change. Thus, the power consumption of the display device 100 is relatively reduced.

Embodiments have been described with respect to the first stage group and the second stage group included in the emission driver with reference to FIG. 8. However, the present disclosure is not limited thereto. For example, the present disclosure may be applied to the stages included in the scan driver, and the present disclosure may also be applied to the data driver.

For example, a display device according to some embodiments of the present disclosure may include a pixel part including a plurality of pixels and a driver supplying a gate control signal to each of the plurality of pixels. The driver may include at least one stage, and during a self-scan period, at least one stage may be supplied with a first clock signal having an unchanging voltage value and a second clock signal having a changing voltage value.

According to some embodiments, the driver may be an emission driver, and the gate control signal may be an emission control signal.

In another example, the driver may be a scan driver, and the gate control signal may be a scan signal.

The display device according to some embodiments may be applied to various electronic devices. An electronic device according to some embodiments includes the above-described display device, and may further include modules or devices having other additional functions in addition to the display device.

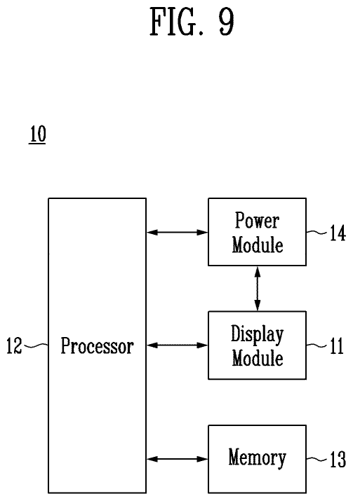

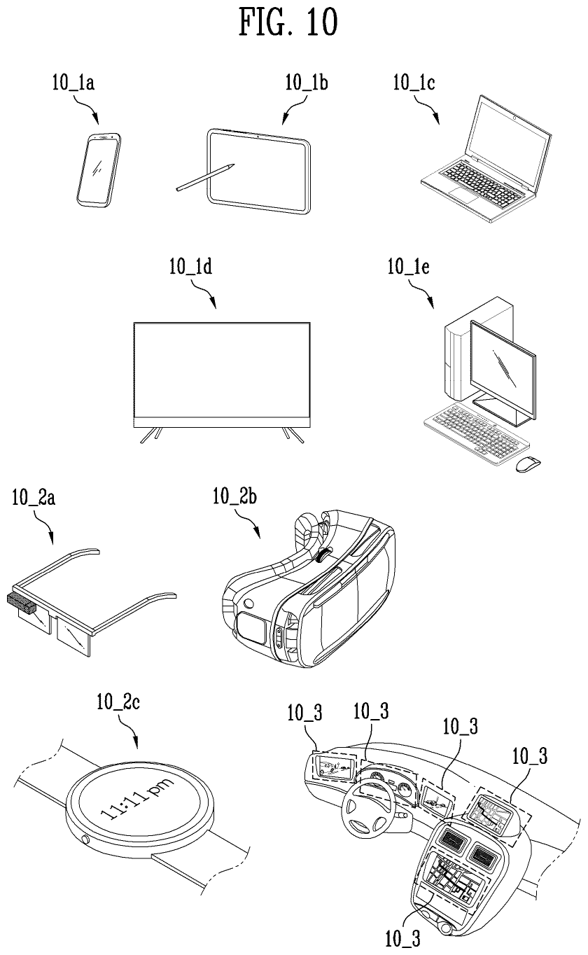

FIG. 9 is a block diagram of the electronic device 10 according to some embodiments. Referring to FIG. 10, the electronic device 10 according to some embodiments may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to the above-described embodiments. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

FIG. 10 shows schematic views of various embodiments of an electronic device.

Referring to FIG. 10, various types of electronic devices to which embodiments of the display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) located at the instrument cluster, the center fascia, and the dashboard of a vehicle, and a room mirror display.

According to some embodiments of the present disclosure, a display device and an electrode device including the same may relatively reduce power consumption.

The embodiments described above are provided to explain the present disclosure, but these embodiments are not intended to limit the scope of the present disclosure. It will be understood by those skilled in the art that various changes, substitutions, and alternatives may be made therein without departing from the scope of the disclosure as set forth by the claims and their equivalents. Therefore, the technical scope of the present disclosure may be determined based on the scope of the accompanying claims and their equivalents.

What is claimed is:

1. A display device, comprising:
a pixel part including a plurality of pixels; and
a driver configured to supply a gate control signal to each of the plurality of pixels,
wherein the driver comprises at least one stage, and a first clock signal having an unchanging voltage value and a second clock signal having a changing voltage value are configured to be applied to the at least one stage during a self-scan period.

2. The display device of claim 1, wherein the first clock signal and the second clock signal having changing voltage values are configured to be supplied to the at least one stage during a display scan period.

3. The display device of claim 2, wherein each of the plurality of pixels comprises a driving transistor, a switching transistor, and a light emitting element, and the switching transistor is connected to the driving transistor, and
wherein the at least one stage is configured to generate the gate control signal, and the gate control signal is configured to be input to a gate terminal of the switching transistor.

4. The display device of claim 1, wherein the driver comprises a first stage group and a second stage group, and each of the first stage group and the second stage group comprises a plurality of stages,
wherein the plurality of stages included in the first stage group are configured to supply first gate control signals to the plurality of pixels, respectively,
wherein the plurality of stages included in the second stage group are configured to supply second gate control signals to the plurality of pixels, respectively, and
wherein the first clock signal having the unchanging voltage value and the second clock signal having the changing voltage value are configured to be applied to the plurality of stages included in the second stage group during the self-scan period.

5. The display device of claim 4, wherein each of the plurality of pixels comprises:
a first transistor having a gate terminal connected to a first node;
a fifth transistor connected between a first power supply voltage and the first transistor;
a second transistor connected between a data line and the first node;
a third transistor connected between a reference power supply voltage and the first node;
a first capacitor connected between the first node and a second node;
a second capacitor connected between the first power supply voltage and the second node;
a sixth transistor connected between the second node and a third node;
a fourth transistor connected between the third node and an initialization power supply voltage; and
a light emitting element connected between the third node and a second power supply voltage.

6. The display device of claim 5, wherein one of the first gate control signals is configured to be input to a gate terminal of the fifth transistor of one of the plurality of pixels, and one of the second gate control signals is configured to be input to a gate terminal of the sixth transistor of one of the plurality of pixels.

7. The display device of claim 4, wherein the second clock signal is configured to be supplied to the plurality of stages included in the first stage group.

8. The display device of claim 4, wherein the first clock signal is not configured to be supplied to the plurality of stages included in the first stage group.

9. A display device, comprising:
a pixel part including a plurality of pixels;
a driver connected to the pixel part through a plurality of gate control lines; and
a timing controller configured to receive video data and to control driving of the driver to display a video corresponding to the video data, wherein the driver comprises:
a first stage group including a plurality of stages configured to supply first gate control signals to the plurality of pixels, respectively; and
a second stage group including a plurality of stages configured to supply second gate control signals to the plurality of pixels, respectively,
wherein at least one stage included in the second stage group is configured to receive a clock signal having a changing voltage value through a first input terminal, and to receive a signal of a direct current component having an unchanging voltage value through a second input terminal during a self-scan period.

10. The display device of claim 9, wherein the at least one stage included in the second stage group receives clock signals having changing voltage values through the first input terminal and the second input terminal, respectively, during a display scan period.

11. The display device of claim 9, wherein each of the plurality of pixels comprises:
a first transistor having a gate terminal connected to a first node;
a fifth transistor connected between a first power supply voltage and the first transistor;
a second transistor connected between a data line and the first node;
a third transistor connected between a reference power supply voltage and the first node;
a first capacitor connected between the first node and a second node;
a second capacitor connected between the first power supply voltage and the second node;
a sixth transistor connected between the second node and a third node;
a fourth transistor connected between the third node and an initialization power supply voltage; and
a light emitting element connected between the third node and a second power supply voltage.

12. The display device of claim 11, wherein the first gate control signal is configured to be input to a gate terminal of the fifth transistor, and the second gate control signal is configured to be input to a gate terminal of the sixth transistor.

13. The display device of claim 9, wherein the clock signal input to the first input terminal of the at least one stage included in the second stage group is configured to be commonly input to at least one stage included in the first stage group.

14. The display device of claim 9, wherein the signal input to the second input terminal of the at least one stage included in the second stage group is not configured to be input to the plurality of stages included in the first stage group.

15. An electronic device, comprising:
a processor configured to provide input video data; and
an electronic device including a display device configured to display a video based on the input video data, wherein the display device comprises:
a pixel part including a plurality of pixels; and
a driver configured to supply a gate control signal to each of the plurality of pixels,
wherein the driver comprises at least one stage, and a first clock signal having an unchanging voltage value and a second clock signal having a changing voltage value are applied to the at least one stage during a self-scan period.

16. The electronic device of claim 15, wherein the driver comprises a first stage group and a second stage group, and each of the first stage group and the second stage group comprises a plurality of stages,
wherein the plurality of stages included in the first stage group are configured to supply first gate control signals to the plurality of pixels, respectively,
wherein the plurality of stages included in the second stage group are configured to supply second gate control signals to the plurality of pixels, respectively, and
wherein the first clock signal having the unchanging voltage value and the second clock signal having the changing voltage value are configured to be applied to the plurality of stages included in the second stage group during the self-scan period.

17. The electronic device of claim 16, wherein each of the plurality of pixels comprises:
a first transistor having a gate terminal connected to a first node;
a fifth transistor connected between a first power supply voltage and the first transistor;
a second transistor connected between a data line and the first node;
a third transistor connected between a reference power supply voltage and the first node;
a first capacitor connected between the first node and a second node;
a second capacitor connected between the first power supply voltage and the second node;
a sixth transistor connected between the second node and a third node;
a fourth transistor connected between the third node and an initialization power supply voltage; and
a light emitting element connected between the third node and a second power supply voltage.

18. The electronic device of claim 17, wherein one of the first gate control signals is configured to be input to a gate terminal of the fifth transistor of one of the plurality of pixels, and one of the second gate control signals is configured to be input to a gate terminal of the sixth transistor of one of the plurality of pixels.

19. The electronic device of claim 16, wherein the second clock signal is configured to be supplied to the plurality of stages included in the first stage group.

20. The electronic device of claim 16, wherein the first clock signal is not configured to be supplied to the plurality of stages included in the first stage group.
